(19) United States
(12) Patent Application Publication
(10) Pub. No.: US 2006/0284938 A1
(43) Pub. Date: Dec. 21, 2006

(54) Inkjet printhead and method of manufacturing the same

(76) Inventors: Jin-wook Lee, Seoul (KR); Yong-shik Park, Seongnam-si (KR); Sung-joon Park, Suwon-si (KR); Myong-jong Kwon, Suwon-si (KR); Kyong-il Kim, Seoul (KR)

Correspondence Address: STANZIONE & KIM, LLP, 919 18TH STREET, N.W., SUITE 440, WASHINGTON, DC, 20006, US

(21) Appl. No.: 11/415,143

(22) Filed: May 2, 2006

(30) Foreign Application Priority Data
Jun. 20, 2005 (KR) 2005-53075
Jan. 9, 2006 (KR) 2006-02369

(51) Int. Cl. B41J 2/045

(52) U.S. Cl. 347/71

(57) ABSTRACT

An Inkjet printhead and a method of manufacturing the same. The inkjet printhead includes a substrate having an ink feedhole, a chamber layer formed on the substrate to define an ink chamber filled with ink supplied though the ink feedhole, and a nozzle layer formed on the chamber layer and having one or more nozzles to eject the ink filled in the chamber, wherein the chamber layer and the nozzle layer are made of solid film resists.

### CROSS-REFERENCE TO RELATED APPLICATIONS

This application claims the benefit of Korean Patent Applications Nos. 2005-53075, filed on Jun. 20, 2005, and 2006-2369, filed on Jan. 9, 2006, in the Korean Intellectual Property Office, the disclosures of which are incorporated herein in their entirety by reference.

### BACKGROUND OF THE INVENTION

1. Field of the Invention

The present general inventive concept relates to an inkjet printhead and a method of manufacturing the same, and more particularly, to a thermal inkjet printhead and a method of manufacturing the same in which thicknesses of a chamber layer and a nozzle layer can be precisely controlled.

2. Description of the Related Art

An inkjet printhead is an apparatus that ejects minute ink droplets on desired positions of recording paper in order to print predetermined color images. The inkjet printhead may be categorized into two types according to an ink droplet ejection mechanism thereof. The first type is a thermal inkjet printhead that ejects ink droplets due to an expansion force of ink bubbles generated by thermal energy. The other type is a piezoelectric inkjet printhead that ejects ink droplets by a pressure applied to ink due to the deformation of a piezoelectric body.

The ink droplet ejection mechanism of the thermal inkjet printhead operates as follows. When a current flows through a heater made of a heating resistor, the heater is heated and ink near the heater in an ink chamber is instantaneously heated up to about 300° C. Accordingly, ink bubbles are generated by ink evaporation, and the generated bubbles are expanded to exert a pressure on the ink filled in the ink chamber. Thereafter, an ink droplet is ejected through a nozzle out of the ink chamber by the exerted pressure.

According to a relationship between a direction in which an ink bubble grows and a direction in which the ink droplet is ejected, the thermal inkjet printhead may be further classified into a top-shooting type, a side-shooting type, or a back-shooting type. In the top-shooting type thermal inkjet printhead, the growing direction of an ink bubble and the ejecting direction of the ink droplet are the same. In the side-shooting type thermal inkjet printhead, the ejection direction of the ink droplet is perpendicular to the growing direction of the ink bubble. In the back-shooting type thermal inkjet printhead, the ejecting direction of the ink droplet is opposite to the growing direction of an ink bubble.

The thermal inkjet printhead should typically satisfy the following conditions. First, a manufacturing process thereof should be simple, inexpensive, and allow for mass production. Second, in order to print high-resolution images, an interval between nozzles in the printhead should be as small as possible without generating cross talk between adjacent nozzles. In other words, a plurality of nozzles should be densely arranged to increase a number of dots per inch (DPI), which affects printing resolution. Third, in order to print with high-speed, a time interval at which ink in an ink chamber is refilled should be very short and simultaneous cooling of the heated ink and heater should be fast, thereby increasing a driving frequency of the printhead as much as possible.

FIGS. 1 through 6B are schematic cross-sectional views illustrating a conventional method of manufacturing a thermal inkjet printhead. Referring to FIG. 1, a chamber layer 12 that defines an ink chamber 13 is formed on a substrate 10. The chamber layer 12 can be formed by coating a first photoresist of a predetermined thickness on the substrate 10 and then patterning the first photoresist. Referring to FIG. 2, a sacrificial layer 15 is formed on the substrate 10 and the chamber layer 12 so as to completely cover the ink chamber 13 formed in the chamber layer 12. Here, the sacrificial layer 15 can be formed by coating a second photoresist of a predetermined thickness on the substrate 10 and the chamber layer 12. Referring to FIG. 3, the sacrificial layer 15 and the chamber layer 12 are then flatly polished using a chemical mechanical polishing (CMP) process. Referring to FIG. 4, a nozzle layer 16 having a nozzle 17 is formed on the chamber layer 12 and the sacrificial layer 15. Specifically, a third photoresist of a predetermined thickness is coated on the chamber layer 12 and the sacrificial layer 15, and the third photoresist is then patterned to form the nozzle 17 using a photolithography process, thereby forming the nozzle layer 16. Next, the sacrificial layer 15 is removed with a solvent and then the ink chamber 13 is formed in the chamber layer 12, as illustrated in FIG. 5. Lastly, referring to FIGS. 6A and 6B, the substrate 10 is vertically etched to form an ink feedhole 11 (i.e., a passage for supplying ink to the ink chamber 13). FIGS. 6A and 6B are cross-sectional views of the conventional inkjet printhead from viewpoint directions that are perpendicular to each other.

In the conventional method of manufacturing an inkjet printhead described above, since a thickness of the chamber layer 12 is controlled only by the CMP process, it is very difficult and expensive to obtain a chamber layer having a uniform thickness. In addition, since the coating and removal of the sacrificial layer are required, the manufacturing process is complicated and a production yield is low.

FIGS. 7 through 9B illustrate another conventional method of manufacturing a thermal inkjet printhead.

Referring to FIG. 7, a chamber layer 22 that defines an ink chamber 23 and an ink feedhole 22 (see FIG. 9B) through which ink is supplied to the ink chamber 23 are formed on a substrate 20. The chamber layer 22 is formed by stacking a first solid film resist (not shown) on the substrate 20 by using a lamination method and patterning the first solid film resist. Next, referring to FIG. 8, a second solid film resist 26′ is stacked on the chamber layer 22 using the lamination method. Referring to FIGS. 9A and 9B, the second solid film resist 26′ is patterned to form a nozzle 27 using a photolithography process, thereby forming a nozzle layer 26 on the chamber layer 22. FIGS. 9A and 9B are cross sectional views of the conventional inkjet printhead from viewpoint directions that are perpendicular to each other.

The other conventional method of manufacturing an inkjet printhead uses a solid film resist instead of a liquid-state resist to form the chamber layer 22 and the nozzle layer 26, which allows thicknesses of the chamber layer 22 and the nozzle layer 26 to be precisely controlled and simplifies the manufacturing process.

In the conventional inkjet printhead having the structure illustrated in FIGS. 7 through 9B, in which the ink chamber 23 and the ink feedhole 21 are formed in the chamber layer 22, a heat treatment process for laminating and exposing the second solid film resist 26′ does not cause a problem, because the ink chamber 23 has an open structure due to the ink feedhole 21 when the nozzle layer 26 made of the second solid film resist 26′ is formed on the chamber layer 22. However, most of present commercial inkjet printheads have a structure in which a substrate is vertically perforated (i.e., below the ink chamber 23) to form an ink feedhole through which ink is supplied to an ink chamber. Accordingly, when these inkjet printheads are formed using a solid film resist, problems occur. Specifically, when a nozzle layer is formed on the chamber layer in an inkjet printhead having a substrate, air in the ink chamber is isolated from outside, unless the substrate is first perforated to form the ink feedhole. Accordingly, the air in the ink chamber is expanded by heat during the heat treatment process, resulting in swelling and deformation of the nozzle layer, as illustrated in FIG. 10.

### SUMMARY OF THE INVENTION

The present general inventive concept provides a thermal inkjet printhead and a simple method of manufacturing the same in which thicknesses of a chamber layer and nozzle layers can be precisely controlled.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an inkjet printhead including a substrate having an ink feedhole extending therethrough, a chamber layer formed on the substrate to define an ink chamber filled with ink supplied though the ink feedhole, and a nozzle layer formed on the chamber layer and having one or more nozzles to eject the ink filled in the ink chamber, wherein the chamber layer and the nozzle layer are made of solid film resists.

The solid film resists may include epoxy group polymers.

The ink feedhole may be perpendicular to a surface of the substrate. A heater to heat the ink in the ink chamber to generate ink bubbles may be formed on an upper portion of the substrate, which corresponds to a bottom of the ink chamber. Conductors to supply an electric current to the heater may be positioned on the upper portion of the substrate.

The foregoing and/or other aspects of the present general inventive concept are also achieved by providing a method of manufacturing an inkjet printhead, the method including perforating a substrate to form an ink feedhole, forming a chamber layer on the substrate of a first solid film resist to define an ink chamber to be filled with ink supplied though the ink feedhole, and forming a nozzle layer on the chamber layer of a second solid film resist to have one or more nozzles to eject the ink filled in the chamber.

The first and second solid film resists may include epoxy group polymers.

The perforating of the substrate to form the ink feedhole may include dry-etching or wet-etching the substrate.

The forming of the chamber layer may include stacking the first solid film resist on the substrate using a lamination method, and forming the ink chamber by patterning the first solid film resist using a photolithography process.

The forming of the nozzle layer may include stacking the second solid film resist on the chamber layer using a lamination method, and forming the one or more nozzles by patterning the second solid film resist using a photolithography process.

The method may be further include, before forming the ink feedhole, forming a heater to heat the ink in the ink chamber to generate ink bubbles on an upper portion of the substrate, which corresponds to a bottom of the ink chamber, and forming conductors to supply an electric current to the heater on the upper portion of the substrate.

The foregoing and/or other aspects of the present general inventive concept are also achieved by providing an inkjet printhead including a substrate having an ink feedhole, a chamber layer formed on the substrate to define an ink chamber filled with ink supplied though the ink feedhole and having at least one throughhole to connect the ink chamber to an outside thereof, and a nozzle layer formed of a solid film resist on the chamber layer having one or more nozzles to eject the ink filled in the ink chamber.

The foregoing and/or other aspects of the present general inventive concept are also achieved by providing a method of manufacturing an inkjet printhead, the method including preparing a substrate, forming a chamber layer on the substrate to define an ink chamber and having at least one throughhole to connect the ink chamber to an outside thereof, forming a nozzle layer having a nozzle on the chamber layer, and forming an ink feedhole on the substrate.

The foregoing and/or other aspects of the present general inventive concept are also achieved by providing an inkjet printhead, including a substrate having an ink feedhole extending therethrough to supply ink, and an ink flow structure formed of a solid film resist on the substrate to define an ink chamber to receive ink from the ink feedhole and having at least one nozzle in fluid communication with the ink chamber to eject ink therefrom.

The foregoing and/or other aspects of the present general inventive concept are also achieved by providing an inkjet printhead, including a substrate having an ink feedhole to supply ink, and an ink flow structure formed on the substrate to define an ink chamber to receive ink from the ink feedhole, the ink flow structure having at least one nozzle in fluid communication with the ink chamber to eject ink therefrom and at least one throughhole to connect the ink chamber to an outside thereof.

The foregoing and/or other aspects of the present general inventive concept are also achieved by providing a method of manufacturing an inkjet printhead, the method including forming an ink feedhole to extend through a substrate, forming a first layer on the substrate to define an ink chamber to receive ink from the ink feedhole, and forming a second layer on the first layer using a heat generating process to define at least one nozzle in fluid communication with the ink chamber to eject ink therefrom.

The foregoing and/or other aspects of the present general inventive concept are also achieved by providing a method of manufacturing an inkjet printhead, the method including forming a first layer on a substrate to define an ink chamber and at least one throughhole extending from the ink chamber along the substrate to an outside thereof, and forming a second layer on the first layer using a heat generating process to define at least one nozzle in fluid communication with the ink chamber to eject ink therefrom.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIGS. 1 through 6B are schematic cross-sectional views illustrating a conventional method of manufacturing a thermal inkjet printhead;

FIGS. 7 through 9B are schematic cross-sectional views illustrating another conventional method of manufacturing a thermal inkjet printhead;

FIG. 10 is a scanning electron microscopy (SEM) photograph illustrating swelling and deformation of a nozzle layer when an inkjet printhead having an ink feedhole perforated through a substrate is manufacture by a conventional method;

FIG. 11 is a schematic plan view illustrating an inkjet printhead according to an embodiment of the present general inventive concept;

FIG. 12 is an exploded perspective view illustrating the inkjet printhead of FIG. 11;

FIGS. 13 through 16 illustrate a method of manufacturing an inkjet printhead according to an embodiment of the present general inventive concept;

FIG. 17 is a SEM photograph illustrating a cross-section of an inkjet printhead manufactured by the method of FIGS. 13 through 16 according to an embodiment of the present general inventive concept;

FIG. 18 is a schematic plan view illustrating an inkjet printhead according to another embodiment of the present general inventive concept;

FIG. 19 is an exploded perspective view illustrating the inkjet printhead of FIG. 18;

FIGS. 20 through 24 illustrate a method of manufacturing an inkjet printhead according to another embodiment of the present general inventive concept; and

FIG. 25 is a schematic cross-sectional view illustrating the inkjet printhead manufactured by the method of FIGS. 20 through 24 mounted in a cartridge.

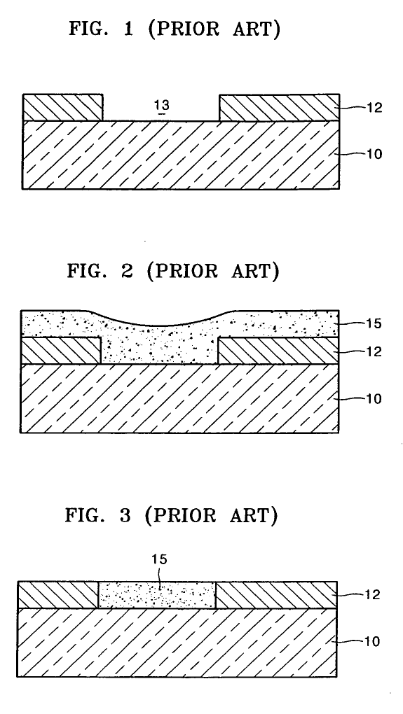

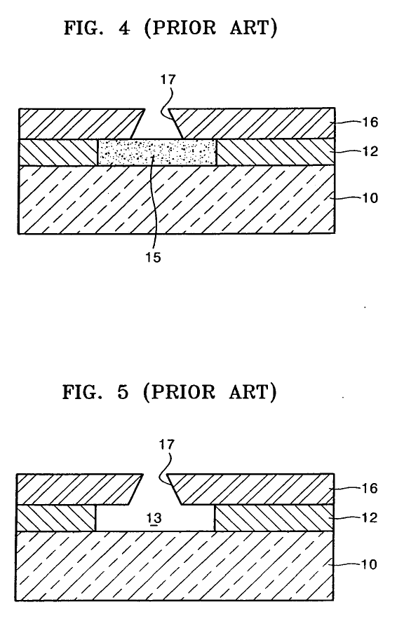

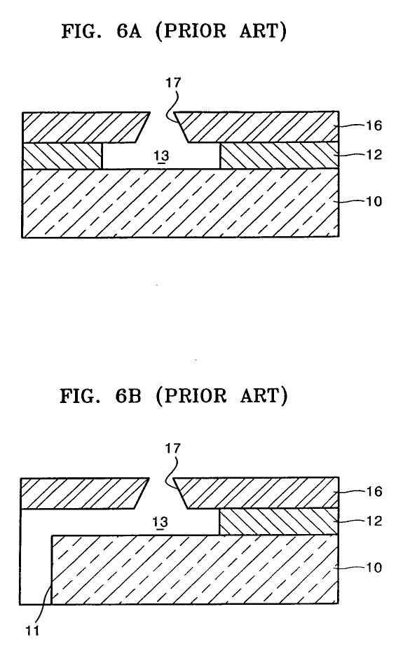

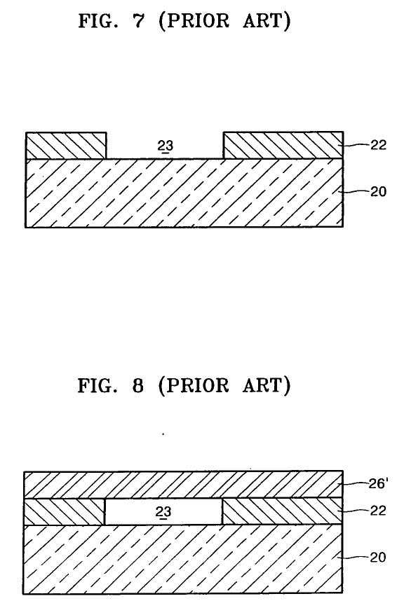

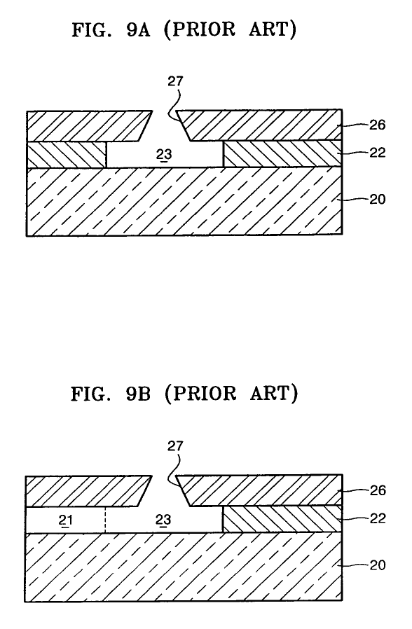

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures. It will also be understood that when a layer is referred to as being “on” another layer or substrate, it can be directly on the other layer or substrate, or intervening layers may also be present.

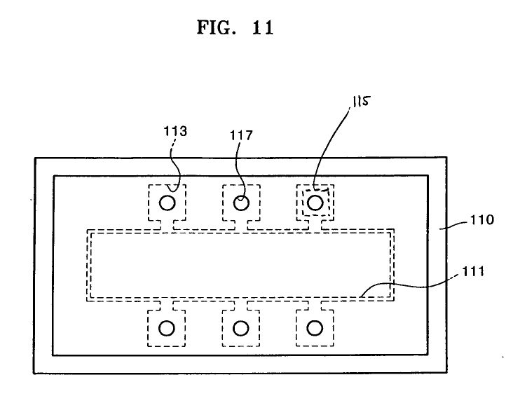

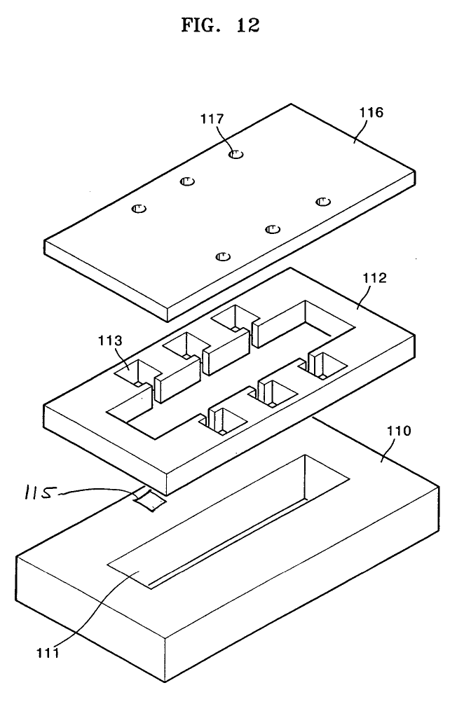

FIG. 11 is a schematic plan view of an inkjet printhead according to an embodiment of the present general inventive concept. FIG. 12 is an exploded perspective view illustrating the inkjet printhead of FIG. 11. Referring to FIGS. 11 and 12, a substrate 110 is vertically perforated to form an ink feedhole 111 (i.e., an ink supplying pathway). A silicon substrate may be used as the substrate 110. A chamber layer 112 that defines an ink chamber 113 filled with ink supplied through the ink feedhole 111 is formed on the substrate 110. The chamber layer 112 can be formed by staking a solid film resist of a predetermined thickness on the substrate 110 and patterning the solid film resist. The solid film resist may be made of epoxy group polymers having excellent chemical resistance and adhesiveness. A heater 115 to heat the ink in the ink chamber 113 to generate ink bubbles is formed on an upper portion of the substrate 110, which corresponds to a bottom of the ink chamber 113. Also, conductors (not shown) are positioned on the same upper portion of the substrate 110 to supply an electric current to the heater 115. The conductors may be formed as part of the heater 115 by the same processes.

A nozzle layer 116 having a nozzle 117 to eject the ink filled in the ink chamber 113 is formed to have a predetermined thickness on the chamber layer 112. The nozzle layer 116 can be formed in a similar manner as the chamber layer 112 by staking a solid film resist of a predetermined thickness on the substrate 110 and patterning the solid film resist. Again, the solid film resist may be made of epoxy group polymers having excellent chemical resistance and adhesiveness.

In the inkjet printhead according to the present embodiment, the thicknesses of the chamber layer 112 and the nozzle layer 116 can be precisely controlled by stacking the solid film resists of the predetermined thickness(es).

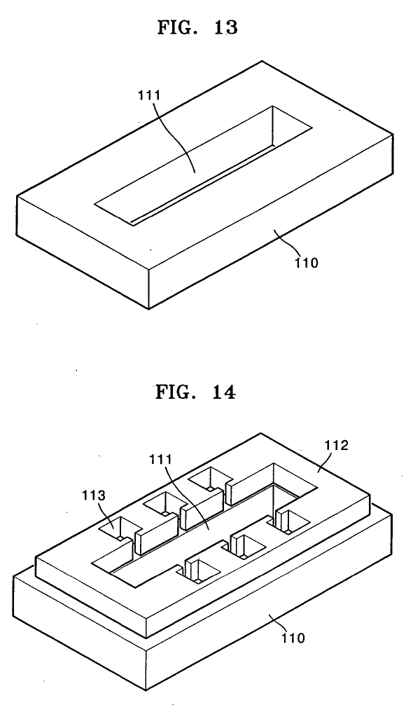

Hereinafter, a method of manufacturing an inkjet printhead according to an embodiment of the present general inventive concept will be described. FIGS. 13 through 16 illustrate the method of manufacturing the inkjet printhead of FIGS. 11 and 12.

Referring to FIG. 13, a substrate 110 is prepared. A silicon substrate may be used as the substrate 110. The ink feedhole 111 to supply the ink to the ink chamber 113 (see FIG. 11) is vertically formed through the substrate 110. Here, the ink feedhole 111 can be formed by dry-etching or wet-etching the substrate 110. Before forming the ink feedhole, the heater 115 to heat the ink in the ink chamber to generate ink bubbles may be formed on the upper portion of the substrate 110, which corresponds to the bottom of the ink chamber 113, and conductors (not shown) to supply the electric current to the heater 115 are positioned on the same upper portion of the substrate 110.

Referring to FIG. 14, the chamber layer 112, which defines the ink chamber 113, is formed on the substrate 110 having the ink feedhole 111. Specifically, a first solid film resist of a first predetermined thickness is stacked on the substrate 110 using a lamination method, and the first solid film resist is patterned using a photolithography process to form the ink chamber 113, thereby forming the chamber layer 112. Here, the first solid film resist may be made of an epoxy group polymer having excellent chemical resistance and adhesiveness. The thickness of the chamber layer 112 can be precisely controlled by using the first solid film resist having the first predetermined thickness.

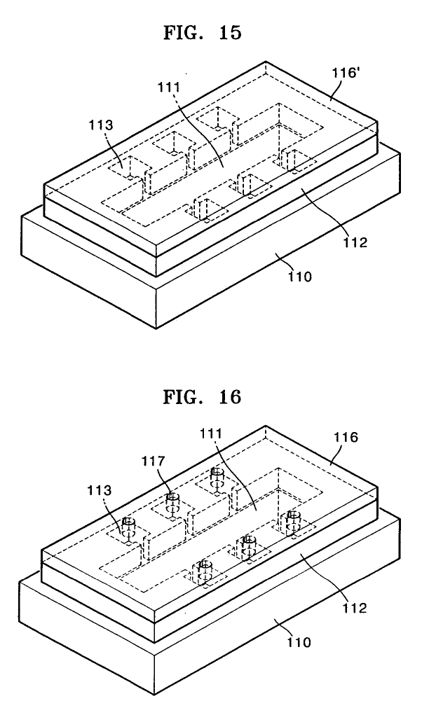

Referring to FIG. 15, a second solid film resist 116′ of a second predetermined thickness is stacked on the chamber layer 112 where the ink chamber 113 is formed. Here, the second solid film resist 116′ is stacked on the chamber layer 112 using the lamination method. The second solid film resist 116′ may be also made of an epoxy group polymer having excellent chemical resistance and adhesiveness.

Lastly, referring to FIG. 16, the second solid film resist 116′ is patterned using the photolithography process to form the nozzle 117 to eject the ink in the ink chamber 113, thereby forming the nozzle layer 116 on the chamber layer 112. The thickness of the nozzle layer 116 can be precisely controlled by using the second solid film resist having the second predetermined thickness.

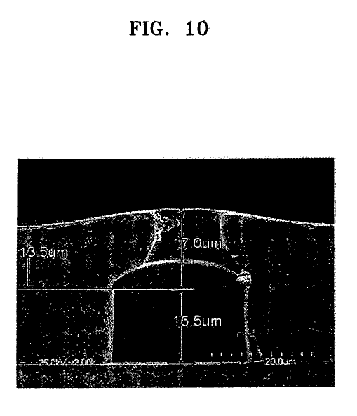

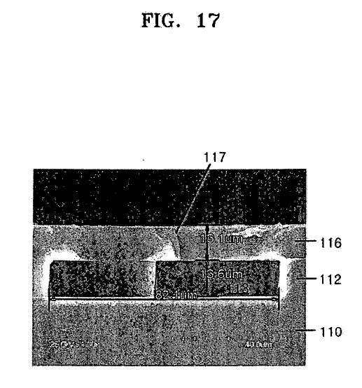

Since the substrate 110 is perforated to form the ink feedhole 111 before forming the nozzle layer 116, the ink chamber 113 is already exposed (i.e., open) through the ink feedhole 111 when the nozzle layer 116 is formed. Accordingly, when a heat treatment process used in the lamination and exposure processes of the second solid film resist 116′ is performed, a swelling and deformation of the nozzle layer 116 do not occur due to the heat that is produced. FIG. 17 is a scanning electron microscopy (SEM) photograph illustrating a cross-section of the inkjet printhead manufactured by the method of FIGS. 12 through 15 according to an embodiment of the present embodiment. The ink feedhole 111 is not illustrated in FIG. 17 for description and illustration purposes. Referring to FIG. 17, the swelling and deformation of a nozzle layer illustrated in FIG. 10, which may occur in the conventional method, does not occur in the present embodiment.

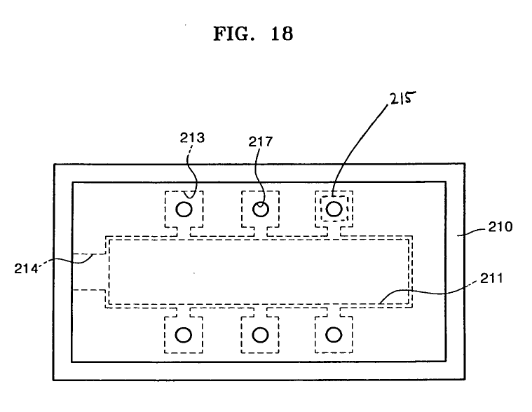

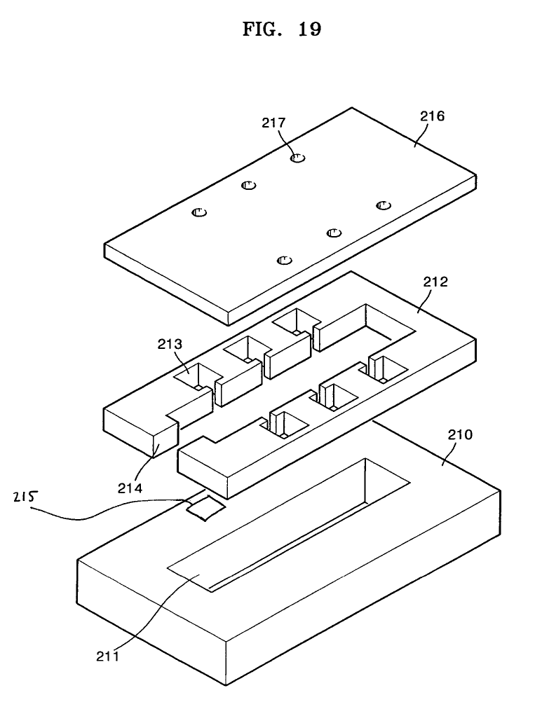

FIG. 18 is a schematic plan view illustrating an inkjet printhead according to another embodiment of the present general inventive concept. FIG. 19 is an exploded perspective view illustrating the inkjet printhead of FIG. 18.

Referring to FIGS. 18 and 19, a substrate 210 is perforated to form an ink feedhole 211. The ink feedhole 211 is perpendicularly formed with respect to a surface of the substrate 210. A silicon substrate may be used as the substrate 210.

A chamber layer 212 that defines an ink chamber 213 filled with ink supplied through the ink feedhole 211 is formed on the substrate 210. In addition, a throughhole 214 is formed in the chamber layer 212 to connect the ink chamber 213 to an outside thereof. When a nozzle layer 216 is formed on the chamber layer 212, which will be described later, the ink chamber 213 is connected to the outside thereof through the throughhole 214 so that a swelling and deformation of the nozzle layer 216 is prevented. The chamber layer 212 can be formed by staking a solid film resist of a first predetermined thickness on the substrate 210 and patterning the solid film resist. The solid film resist may be made of epoxy group polymers having excellent chemical resistance and adhesiveness. Alternatively, the chamber layer 212 may be formed by applying a liquid resist on the substrate 210 and patterning the liquid resist. Although the throughhole 214 is illustrated in FIGS. 18 and 19 as being a single throughhole 214, it should be understood that more than one throughholes 214 may be formed in the chamber layer 212. The throughhole 214 formed in the chamber layer 212 is subsequently sealed by a sealant 250 (see FIG. 25) when the inkjet printhead is mounted in a cartridge 230 (see FIG. 25), and thus the ink inside of the inkjet printhead cannot leak. A heater 215 is formed on an upper portion of the substrate 210, which corresponds to a bottom of the ink chamber 213, to heat the ink in the ink chamber 213 to generate ink bubbles. Also, conductors (not shown) are positioned on the same upper portion of the substrate 210 to supply an electric current to the heater 215.

The nozzle layer 216 having a nozzle 217 to eject the ink filled in the ink chamber 213 is formed on the chamber layer 212. The nozzle layer 216 can be formed by staking a solid film resist of a second predetermined thickness on the chamber layer 212 and patterning the solid film resist. Here, the solid film resist may be made of epoxy group polymers having excellent chemical resistance and adhesiveness.

In the inkjet printhead according to the present embodiment, a thickness of the nozzle layer 216 can be precisely controlled by stacking the solid film resist of the second predetermined thickness. When the chamber layer 212 is made of a solid film resist, a thickness of the chamber layer 212 can be precisely controlled in a similar manner.

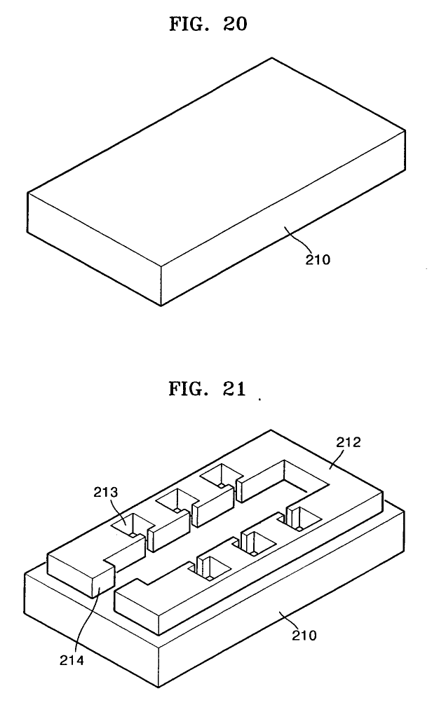

Hereinafter, a method of manufacturing an inkjet printhead according to another embodiment of the present general inventive concept will be described. FIGS. 20 through 24 illustrate the method of manufacturing the inkjet printhead of FIGS. 18 and 19.

Referring to FIG. 20, the substrate 210 is prepared. A silicon substrate may be used as the substrate 210. Referring to FIG. 21, the chamber layer 212 is formed on the substrate 210. The ink chamber 213 that is filled with ink and the throughhole 214 to connect the ink chamber 213 to the outside is formed in the chamber layer 212. One or more throughholes 214 may be formed in the chamber layer 212. A solid film resist (not illustrated) having a first predetermined thickness is stacked on the substrate 210 using a lamination method, and the solid film resist is then patterned using a photolithography process to form the chamber layer 212. Here, the solid film resist may be made of an epoxy group polymer having excellent chemical resistance and adhesiveness. A thickness of the chamber layer 212 can be precisely controlled by using the solid film resist having the first predetermined thickness. Alternatively, the chamber layer 212 may be formed by applying a liquid resist (not illustrated) on the substrate 210 and patterning the liquid resist.

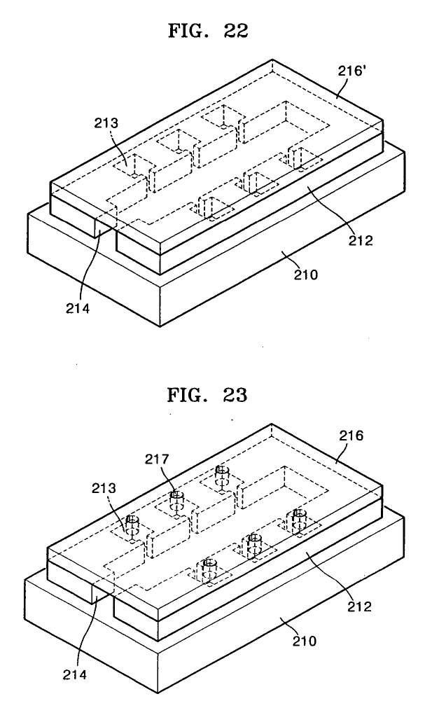

Referring to FIG. 22, a second solid film resist 216′ is stacked on the chamber layer 212 using the lamination method to form the nozzle layer 216. Here, the second solid film resist 216′ may be made of an epoxy group polymer, as described above. The solid film resist usable to form the chamber layer 212 may be the same as or different from the second solid film resist 216′ used to form the nozzle layer 216′. Referring to FIG. 23, the second solid film resist 216′ is patterned using a photolithography process, thereby forming the nozzle layer 216 in which the nozzle 217 to eject the ink is formed. The thickness of the nozzle layer 216 can be precisely controlled by using the solid film resist 216′ having a second predetermined thickness. In addition, when the second solid film resist 216′ is stacked on the chamber layer 212, and patterned to form the nozzle layer 216, the ink chamber 213 is connected to the outside thereof through the throughhole 214. Accordingly, when a heat treatment process used in the lamination and exposure processes of the solid film resist 216′ is performed, a swelling and deformation of the nozzle layer 216 does not occur because of heat generated in these processes.

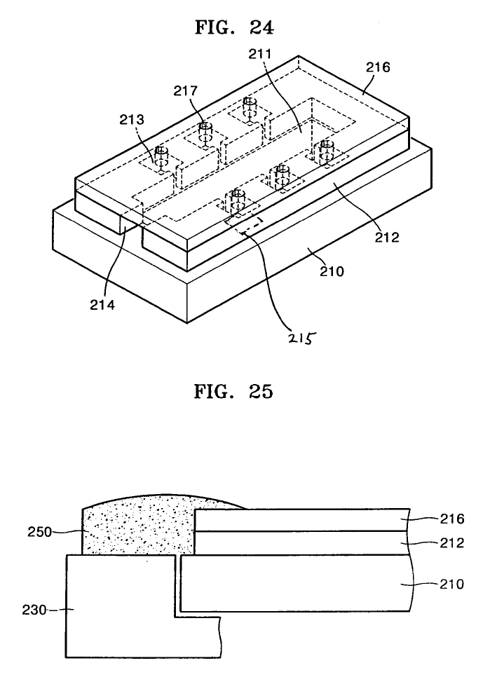

Referring to FIG. 24, the substrate 210 is perforated by etching to form the ink feedhole 211 through which ink is supplied to the ink chamber 213. Therefore, the inkjet printhead according to the present embodiment is complete. The ink feedhole 211 is perpendicularly formed with respect to the surface of the substrate 210. The ink feedhole 211 is formed by dry etching or wet etching the substrate 210.

FIG. 25 is a schematic cross-sectional view illustrating the inkjet printhead manufactured by the method of FIGS. 20 through 24 mounted to the cartridge 230. Referring to FIG. 25, the inkjet printhead including the substrate 210, the chamber layer 212, and the nozzle layer 216 mounted to the cartridge 230 using the sealant 250 made of an adhesive material. The throughhole 214 (see FIG. 24) formed in the chamber layer 212 is sealed by the sealant 250, and thus the ink inside of the inkjet printhead cannot leak.

A method of manufacturing an inkjet printhead according to the various embodiments of the present general inventive concept provides an inkjet printhead having excellent chemical resistance and adhesiveness, since a chamber layer and a nozzle layer thereof are formed of solid film resists made of epoxy group polymers. Additionally, a process of manufacturing the inkjet printhead is simple and has a high production yield, since the chamber layer and the nozzle layer are formed by stacking solid film resists using a lamination method. Furthermore, thicknesses of the chamber layer and the nozzle layer can be precisely controlled since the solid film resists of predetermined thicknesses are used. Also, swelling and deformation of the nozzle layer can be prevented, since the nozzle layer is formed after perforating the substrate to form an ink feedhole, or the nozzle layer is formed on the chamber layer having the throughhole.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printhead, comprising:
a substrate having an ink feedhole extending therethrough;
a chamber layer formed on the substrate to define an ink chamber filled with ink supplied though the ink feedhole; and
a nozzle layer formed on the chamber layer and having nozzles to eject the ink filled in the ink chamber,
wherein the chamber layer and the nozzle layer are made of solid film resists.

2. The inkjet printhead of claim 1, wherein the solid film resists comprise epoxy group polymers.

3. The inkjet printhead of claim 1, wherein the ink feedhole is perpendicular to a surface of the substrate.

4. The inkjet printhead of claim 1, further comprising:
a heater to heat the ink in the ink chamber to generate ink bubbles formed on an upper portion of the substrate, which corresponds to a bottom of the ink chamber, the heater including conductors positioned on the upper portion of the substrate to supply an electric current thereto.

5. The inkjet printhead of claim 1, further comprising:
one or more throughholes extending through the chamber layer parallel to the substrate to allow air to flow in and out of the ink chamber during a manufacturing process.

6. The inkjet printhead of claim 5, further comprising:
a sealant to seal the one or more throughholes such that the ink in the ink chamber does not leak therefrom.

7. A method of manufacturing an inkjet printhead, the method comprising:
perforating a substrate to form an ink feedhole;
forming a chamber layer of a first solid film resist on the substrate to define an ink chamber to be filled with ink supplied through the ink feedhole; and
forming a nozzle layer of a second solid film resist on the chamber layer to have one or more nozzles to eject the ink filled in the chamber.

8. The method of claim 7, wherein the first and second solid film resists comprise epoxy group polymers.

9. The method of claim 7, wherein the perforating of the substrate to form the ink feedhole comprises dry-etching or wet-etching the substrate.

10. The method of claim 9, wherein the perforating of the substrate to form the ink feedhole comprises forming the ink feedhole to be perpendicular to a surface of the substrate.

11. The method of claim 7, wherein the forming of the chamber layer comprises:
stacking the first solid film resist on the substrate using a lamination method; and
forming the ink chamber by patterning the first solid film resist using a photolithography process.

12. The method of claim 7, wherein the forming of the nozzle layer comprises:
stacking the second solid film resist on the chamber layer using a lamination method; and
forming the one or more nozzles by patterning the second solid film resist using a photolithography process.

13. The method of claim 7, wherein the forming of the nozzle layer comprises applying heat to the second solid film resist.

14. The method of claim 7, wherein:
the forming of the chamber layer comprises applying a layer of the first solid film resist having a first predetermined thickness; and
the forming of the nozzle layer comprises applying a layer of the second solid film resist of a second predetermined thickness without any sacrificial layer.

15. The method of claim 7, further comprising:
before forming the ink feedhole, forming a heater to heat the ink in the ink chamber to generate ink bubbles on an upper portion of the substrate, which corresponds to a bottom of the ink chamber, the heater including conductors to supply an electric current thereto on the upper portion of the substrate.

16. An inkjet printhead comprising:
a substrate having an ink feedhole;
a chamber layer formed on the substrate to define an ink chamber filled with ink supplied though the ink feedhole, and having at least one throughhole to connect the ink chamber to an outside thereof; and
a nozzle layer formed on the chamber layer of a solid film resist and having one or more nozzles to eject ink filled in the ink chamber.

17. The inkjet printhead of claim 16, wherein the at least one throughhole extends through the chamber layer parallel to the substrate and includes a sealant to prevent ink from leaking from the ink chamber.

18. The inkjet printhead of claim 16, wherein the solid film resist comprises epoxy group polymers.

19. A method of manufacturing an inkjet printhead, the method comprising:
preparing a substrate;
forming a chamber layer on the substrate to define an ink chamber and having at least one throughhole to connect the ink chamber to an outside thereof;
forming a nozzle layer having a nozzle on the chamber layer; and
forming an ink feedhole on the substrate.

20. The method of claim 19, wherein the forming of the nozzle layer comprises:
stacking a solid film resist on the chamber layer using a lamination method; and
forming the nozzle by patterning the solid film resist using a photolithography process.

21. The method of claim 20, wherein the solid film resist comprises epoxy group polymers.

22. The method of claim 19, wherein the forming of the nozzle layer comprises applying a solid film resist in a heat generating process.

23. The method of claim 19, wherein the forming of the chamber layer comprises:
applying a liquid resist on the substrate and patterning the liquid resist using photolithography.

24. The method of claim 19, wherein the forming of the chamber layer comprises:
stacking a solid film resist on the substrate using a lamination method; and
forming the ink chamber and the at least one throughhole by patterning the solid film resist using a photolithography process.

25. An inkjet printhead, comprising:
a substrate having an ink feedhole extending therethrough to supply ink; and
an ink flow structure formed of a solid film resist on the substrate to define an ink chamber to receive ink from the ink feedhole and having at least one nozzle in fluid communication with the ink chamber to eject ink therefrom.

26. The inkjet printhead of claim 25, wherein:
the ink chamber comprises a plurality of ink chambers on the substrate disposed around sides of the ink feed hole; and
the nozzle comprises a plurality of nozzles corresponding to each of the ink chambers.

27. An inkjet printhead, comprising:
a substrate having an ink feedhole to supply ink; and
an ink flow structure formed on the substrate to define an ink chamber to receive ink from the ink feedhole, the ink flow structure having at least one nozzle in fluid communication with the ink chamber to eject ink therefrom and at least one throughhole to connect the ink chamber to an outside thereof.

28. The inkjet printhead of claim 27, further comprising:
a sealant to seal the at least one throughhole upon completion of a manufacturing process to prevent the ink from leaking from the ink chamber

29. A method of manufacturing an inkjet printhead, the method comprising:
forming an ink feedhole to extend through a substrate;
forming a first layer on the substrate to define an ink chamber to receive ink from the ink feedhole; and
forming a second layer on the first layer using a heat generating process to define at least one nozzle in fluid communication with the ink chamber to eject ink therefrom.

30. A method of manufacturing an inkjet printhead, the method comprising:
forming a first layer on a substrate to define an ink chamber and at least one throughhole extending from the ink chamber along the substrate to an outside thereof; and
forming a second layer on the first layer using a heat generating process to define at least one nozzle in fluid communication with the ink chamber to eject ink therefrom.
